(19) United States
(12) Patent Application Publication
(10) Pub. No.: US 2024/0058208 A1
(43) Pub. Date: Feb. 22, 2024

(54) MASSAGE APPARATUS

(71) Applicant: Alexander Adam Sutherland, Surrey (GB)

(72) Inventor: Alexander Adam Sutherland, Surrey (GB)

(21) Appl. No.: 18/271,680

(22) PCT Filed: Jan. 11, 2021
(86) PCT No.: PCT/EP2021/050379

§ 371 Date: Jul. 11, 2023

(51) Int. Cl. A61H 23/00

(52) U.S. Cl. CPC A61H 23/006; A61H 2201/0126; A61H 2201/1623; A61H 2201/1635

(57) ABSTRACT

An apparatus for use in massage comprises an extended structural support element, at least one massage member and two gripping members, which two gripping members are laterally disposed on the structural support element relative to one another. It is configured such that a user in a standing position with their arms at rest by their sides may grip the two gripping members, when the support structure is disposed behind them, and manipulate the apparatus to massage a position on their back. The apparatus enables a user to independently massage their back to relieve pain and/or tension or to relax, while maintaining a neutral body position and without inordinately straining or twisting any area of their body to impart a massaging force on their back.

### FIELD OF THE INVENTION

The present invention pertains generally to the field of apparatus for massage. More particularly, the present invention relates to apparatus for independent back massage.

### BACKGROUND OF THE INVENTION

Many individuals develop mechanical pain or tension in their back as a result of over-strenuous activities, such as through continuous or repetitive exercise or movement. Often, in such cases, active or latent myofascial trigger points develop within the muscle fibres and/or in the fascia tissue of the back. In other cases, many individuals develop inflammatory pain or tension in their back.

Individuals with pain or tension in their back regularly require massage to relieve or reduce their symptoms. Similarly, individuals without pain or tension in their back simply enjoy and are relaxed by massage.

Many individuals requiring or wanting their back to be regularly massaged cannot access a masseuse due to time, travel, availability and/or cost constraints. As such, several back massage apparatuses have been developed to allow a user to independently massage their back in their own home or workplace.

Known independent back massage tools have several shortcomings. Not least, users of such tools must hold/grip the tools in unnatural, twisted and/or non-neutral positions, they must strain other areas of the body in order for the tool to have a massaging effect on their back, and/or the tools cannot selectively target discrete areas (such as myofascial trigger points) of the back.

The present inventor has found a solution to the aforementioned shortcomings in back massage tools.

### Problem to be Solved by the Invention

It is an object of the invention to provide an improved back massage apparatus for allowing a user to independently relieve mechanical or inflammatory back pain or tension, and/or to massage their back for the purpose of relaxation.

### SUMMARY OF THE INVENTION

In accordance with a first aspect of the invention, there is provided an apparatus for use in massage, the apparatus comprising an extended structural support element. Disposed at a first end portion of the structural support element is at least one massage member and at a second end portion distal to the first end portion two gripping members, which two gripping members are laterally disposed on the structural support element relative to one another. The apparatus is configured such that a user in a standing position with their arms at rest by their sides may grip the two gripping members, when the support structure is disposed behind the user, and manipulate the apparatus to massage a position on the back of the user.

In a second aspect of the invention, there is provided a method of massaging using the apparatus of the first aspect, the method comprising: a user positioning the apparatus to their rear and gripping the two gripping members at their sides, such that their spine and arms are in a neutral position; the user leaning their middle to upper back (or optionally lower back) against the massage member of the apparatus, which apparatus is braced against a wall; the user adjusting the pressure they impart on their back by leaning and/or adjusting the position of contact with the massage member for optimal massaging while maintaining a neutral spine position.

### Advantages of the Invention

The apparatus and method of the invention enables a user to independently massage their back to relieve pain and/or tension or to relax, while maintaining a neutral body position and without inordinately straining or twisting any area of their body to impart a massaging force on their back.

### BRIEF DESCRIPTION OF THE DRAWINGS

FIG. 1 is a frontal view of an embodiment of the apparatus for massage; and

FIG. 2 is a cross-sectional view of an embodiment of the apparatus for massage.

### DETAILED DESCRIPTION OF THE INVENTION

The invention is directed to an apparatus for use in massage, the apparatus comprising an extended structural support element. Disposed at a first end portion of the structural support element is at least one massage member. Disposed at a second end portion distal to the first end portion are two gripping members, which two gripping members are laterally disposed on the structural support element relative to one another. The apparatus is configured such that a user in a standing position with their arms at rest by their sides may grip the two gripping members, when the support structure is disposed behind the user, and manipulate the apparatus to massage a position on the back of the user (such as, the upper back of the user).

Preferably, at least a portion (e.g. up to all) of the at least one massage member (e.g. not including an interchangeable massage head(s) as defined below) and/or at least a portion of each of the two gripping members (e.g. the two gripping members) are fixedly connected to (e.g. integral with) the extended structural support member. More preferably, the extended structural support element is integral with the two gripping members and the at least one massage member (not including an interchangeable massage head(s) as defined below).

The extended structural support element may be of any suitable shape. Preferably, the shape of the extended structural support element has at least one mirror plane for improved balance of the massage apparatus. More preferably, the at least one mirror plane extends through the first end portion and the second end portion. For example, the extended structural support element may be a trapezoid shape, such as an isosceles, rectangle or square.

Preferably, the extended structural support element is widest at the second end portion and narrows towards the first end portion. More preferably, the shape of the extended structural support element is substantially triangular (the second end portion being proximal to a base of the triangular shape) such that the weight and size of the massage apparatus is minimised for improved usability.

The second end portion may be understood to be disposed at or around a bottom of the massage apparatus and the first end portion may be understood to be disposed at or around a top of the massage apparatus.

Preferably, the structural support element is configured to be braced against a flat surface (such as a wall), such that a user, when gripping the device behind their back, can lean their back against the braced massage apparatus and/or the at least one massage member in a neutral standing position.

Preferably, the structural support element, when braced, is configured to be stable relative the flat surface. e.g. the structural support element cannot pivot relative to the flat surface. More preferably, when braced, the structural support element may only move relative the flat surface in one dimension. e.g. by sliding across the flat surface.

In one embodiment, the structural support element is configured to be braced against a flat surface with at least two points of contact between the massage apparatus and the flat surface, preferably at least three points of contact, for improved stability.

In the same or a further embodiment, the extended structural support element preferably comprises a frame, such as a peripheral frame defining the shape of the extended structural support element. The frame preferably comprises one or more scaffold or rod pieces. More preferably, the one or more scaffold or rod pieces may be a single integral piece, or an arrangement of pieces joined by at least one attachment means. Such an attachment means may, for example, include joints, brackets and/or adhesive. The extended structural support element may, for example, comprise three scaffold pieces and three corner joints to form an extended isosceles triangle shape. In a further example, the extended structural support element may comprise a single integral piece with at least 3 bends/angles.

Preferably, the extended structural support element comprises a planar body configured to abut a planar surface, such as a wall. More preferably, the planar body has a planar back surface configured to abut a planar surface. In embodiments of the massage apparatus comprising a planar body and/or planar back surface at least one point of contact is required between the massage apparatus and planar surface, wherein a first point of contact has a planar contact area sufficiently large to affect, when braced, stability of the apparatus relative the flat surface.

Preferably, a position at which the at least one massage member is disposed on the structural support element and the positions at which the at least two gripping members are disposed on the structural element together define a plane.

Optionally, a roller arrangement and/or low-friction material may be disposed on the extended structural support about a back side of the plane and/or on a planar back surface. For example, at least one roller ball-bearing arrangement may be disposed on the extended structural support about a back side of the plane and/or on a planar back surface. In a further example, one or more material(s) with a low coefficient of kinetic friction (μₖ) is disposed on the extended structural support about a back side of the plane and/or on a planar back surface. Suitable materials with a low coefficient of kinetic friction (μₖ) include polytetrafluoroethylene (PTFE), polyimide, polyetheretherketone (PEEK), polyphenylenesulfide (PPS), nylon, acetal and polyester. Preferably, the roller arrangement and/or low-friction material may be configured to minimise any damage and/or wear and tear on a flat surface on which the apparatus is braced during use. For example, the back side of the plane and/or the planar back surface may further comprise a cushioned and/or resilient element to aid in minimising damage and/or wear and tear on a flat surface on which the apparatus is braced during use.

Preferably, the extended structural support element has a height of at least 20 cm, more preferably at least 30 cm, still more preferably at least 35 cm, most preferably at least 40 cm, for example from 45 cm to 100 cm.

Preferably, the extended structural support element has a width of at least 30 cm, more preferably at least 35 cm, most preferably at least 40 cm, for example from 45 cm to 75 cm.

The extended structural support element may be formed from any one or combination of suitable material(s). Preferably, the extended structural support element is comprised from a material or materials of sufficient strength and rigidity such that the massage apparatus is durable. More preferably, the extended structural support element is formed from any one or combination of wood, metal or hard/rigid polymer/plastic.

Preferably, the two gripping members are configured to be gripped from a front side of the plane of the extended structural support element. The two gripping members comprise any suitable arrangement for allowing a user to support the weight of the massage apparatus and/or to manipulate the position of the massage apparatus along a flat surface. For example, a surface may be a flat surface, such as a wall. More preferably, the two gripping members are disposed on the front surface of the extended structural support element and/or a front of a planar body. For example, the two gripping members may be handles indented into or cut out of a front surface of the extended structural support element and/or the front of the planar body. Most preferably, the two gripping members each comprise a handle that protrudes away from the front surface of the extended structural support element and/or the front of the planar body. Optionally, the two gripping members together comprise a single adjoining handle that protrudes away from the front surface of the extended structural support element and/or the front of the planar body.

Preferably, the handles or single adjoining handle comprise(s) a gripping portion configured such that a user may grip the massage apparatus with their hands in a neutral gripping position. The gripping portion is preferably linear and/or comprises a linear longitudinal axis. A neutral gripping position is understood to mean a user's hands grip the massage apparatus in a position substantially similar to the position of their hands and/or wrists when at rest by their side. More preferably, the gripping portion is arranged relative the front side of the plane of the extended structural support element at an acute angle of from 75° to 90°. Most preferably, the gripping portion extends perpendicularly away from the front side of the plane of the extended structural support element. Preferably, the handles extend away from the front side of the plane by a distance perpendicular to the plane of at least 8 cm, more preferably at least 10 cm, such as up to 20 cm or up to 16 cm, most preferably at least 12 cm, for example about 13 cm. When gripping the gripping portion in a neutral gripping position a user may massage their back without positioning their body in an unnatural, twisted and/or non-neutral position to provide an improved massage experience.

Preferably, the positions at which the two gripping members are disposed on the structural support element define a first axis.

The distance between the two gripping members may be adjustable or may be fixed. In embodiments where the two gripping members are adjustable, the distance between the two gripping members is preferably adjustable along the first axis. More preferably, the two gripping members are adjusted cooperatively, such that the position of a centre point between the two gripping members remains constant before and after any adjustment.

Preferably, the distance between the two gripping members is at least 30 cm, more preferably at least 35 cm and most preferably at least 40 cm. In one example, the distance between the two gripping members is from 32.5 cm to 80 cm, or in a second example from 45 cm to 70 cm.

The two gripping members may be formed from any one or combination of suitable material(s). Preferably, the two gripping members are comprised from a durable material or materials. Most preferably, the extended structural support element is comprised from any one or combination of wood, metal or hard/rigid polymer/plastic.

Optionally, the two gripping members comprise a cushioned and/or padded gripping surface. For example, the surface of the two gripping members may comprise a resilient foam material, alternatively, in a further example, the surface may comprise a gel padding. In a still further example, the gripping members may comprise a resilient polymer surface configured to mould to the shape a user's hand when gripped.

Optionally, the two gripping members are configured such that the massage apparatus may support itself in an upright position on a floor, preferably by way of the second end portion and/or the bottom of the massage apparatus and the two gripping members being in contact with the floor. A massage apparatus which is self-supporting on a floor may be preferable for improved ease of access in use and/or improved ease of storage.

Preferably, the at least one massage member is used to massage a position on the back of the user. More preferably, the at least one massage member is configured to massage a discrete position on the back of the user. For example, the at least one massage member may be configured to massage an active or latent myofascial trigger point located on a user's back.

In one embodiment, the massage member protrudes from a front side of the plane defined by the position at which the at least one massage member and the at least two gripping members is/are disposed on the structural support element.

Preferably, the massage member is medially disposed on the structural support element. More preferably, the at least one massage member is disposed on a second axis perpendicular to and medially intersecting the first axis, which first axis is defined by the positions at which the two gripping members are disposed on the structural support element.

Optionally, the distance between the at least one massage member and the first axis is adjustable (or it may be fixed). Preferably, in this option, the distance between the at least one massage member and the first axis is adjustable along the second axis.

Preferably, the distance between the at least one massage member and the first axis is at least 15 cm, more preferably at least 25 cm, still more preferably at least 30 and most preferably at least 35 cm, and preferably up to 55 cm. For example, the distance between the at least one massage member and the first axis may be in the range from 37.5 cm to 50 cm.

Preferably, in any embodiment, the at least one massage member comprises a massage head, which massage head is interchangeable.

Optionally, the at least one massage member comprises a vibration, heat or mechanical massaging function. For example, the at least one massage member may comprise a mechanical shiatsu massager and/or a chemical/electrical heat pad and/or an electric vibrational function.

In one embodiment, the apparatus comprises a singular massage member, such that a user can selectively massage a discrete area of their back. Optionally, the singular massage member comprises a massage head, which massage head is interchangeable.

Optionally, the apparatus for massage is provided in a kit, the kit further comprising one or more interchangeable massage heads. Preferably, the one or more interchangeable massage heads may comprise massage heads of varying shape, rigidity, resilience and/or function. For example, a head may have a hemi-spherical shape, an extended protrusion, an angled outer surface, a ridged outer surface, a pimpled outer surfaces or it may comprises of a plurality or rack of balls or bearings, or it may have a cushioned surface.

In a preferred embodiment, the position at which the at least one massage member is disposed on the structural support element and the positions at which the at least two gripping members are disposed on the structural support element together define a plane and the at least one massage member protrudes from a front side of the plane. More preferably, the at least one massage member protrudes from, and the gripping members are configured to be gripped from, a front side of the plane.

In a second preferred embodiment there is provided an apparatus for use in massage, the apparatus comprising an extended structural support element. Disposed at a first end portion of the structural support element is a single massage member and at a second end portion distal to the first end portion are two gripping members, which two gripping members are laterally disposed on the structural support element relative to one another. The apparatus is configured such that a user in a standing position with their arms at rest by their sides may grip the two gripping members, when the support structure is disposed behind the user, and manipulate the apparatus to massage a position on the back of the user. Preferably, a position at which the single massage member is disposed on the structural support element and the positions at which the at least two gripping members are disposed on the structural support element together define a plane. Preferably, the massage member protrudes from, and the gripping members are configured to be gripped from, a front side of the plane. Preferably, the extended structural support element comprises a planar body having a planar back surface, wherein the extended structural support element, the planar body and/or the planar back surface are configured to abut a planar surface, such as a wall. Preferably, the positions at which the two gripping members are disposed on the structural support element define a first axis, and the at least one massage member is disposed on a second axis perpendicular to and medially intersecting the first axis.

Optionally, the distance between the two gripping members, and the distance between the at least one massage member and the first axis, is adjustable.

In a further aspect of the invention there is provided a method (e.g. a non-therapeutic method) of massaging using the apparatus provided, the method comprising a user positioning the apparatus to their rear and gripping the two gripping members at their sides, such that their spine and arms are in a neutral position; the user leaning their middle to upper back (and/or optionally their lower back) against the massage member of the apparatus, which apparatus is braced against a wall; and the user adjusting the pressure they impart on their back by leaning and/or adjusting the position of contact with the massage member for optimal massaging while maintaining a neutral spine position. Preferably, the user gripping the two gripping members may adjust the position of contact with the massage member by manipulating the position of the massage apparatus along the wall.

The invention will now be described in more detail, without limitation, with reference to the accompanying Figures.

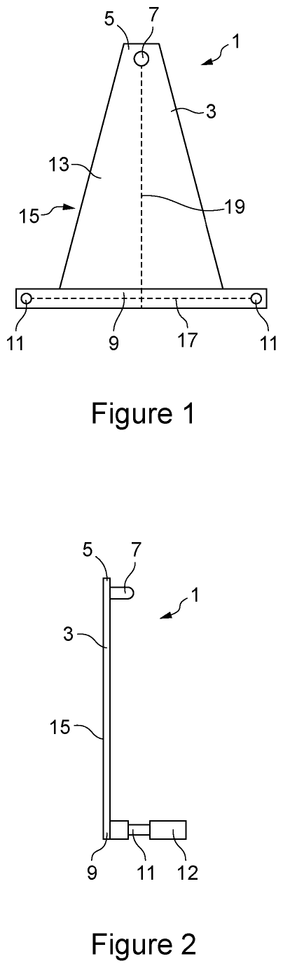

As shown in FIG. 1, apparatus (1) for use in massage comprises an extended structural support element (3). Disposed at a first end portion (5) of the structural support element (3) is a single massage member (7) configured for massaging a discrete area of a user's back, such as an active or latent myofascial trigger point. Disposed at a second end portion (9) distal to the first end portion (5) are two gripping members (11), which two gripping members (11) are laterally disposed on the structural support element (3) relative to one another such that a user can position their body/hips/waist between the two gripping members (11). The extended structural support element (3) is substantially triangular, the second end portion (9) being proximal to a base of the triangular shape. The positions at which the two gripping members (11) are disposed on the structural support element (3) define a first axis (17), and the single massage member (7) is disposed on a second axis (19) perpendicular to and medially intersecting the first axis (17). The apparatus (1) is configured such that a user in a standing position with their arms at rest by their sides may grip the two gripping members (11), when the support structure (3) is disposed behind the user, and manipulate the apparatus to massage a position on the back of the user. The extended structural support element (3) further comprises a planar body (13) having a planar back surface (15, not shown), which planar back surface (15) is configured to be braced against a flat surface such as a wall.

As shown in FIG. 2, apparatus (1) for use in massage comprises an extended structural support element (3). Disposed at a first end portion (5) of the structural support element (3) is a single massage member (7) configured for massaging a discrete area of a user's back, such as an active or latent myofascial trigger point. Disposed at a second end portion (9) distal to the first end portion (5) are two gripping members (11, second of two gripping members not shown), which two gripping members (11) are laterally disposed on the structural support element (3) relative to one another such that a user can position their body/hips/waist between the two gripping members (11). The gripping members (11) comprises a cushioned gripping surface (12) for improving a user's comfort when gripping the apparatus (1). The apparatus (1) is configured such that a user in a standing position with their arms at rest by their sides may grip the two gripping members (11), when the extended structural support element (3) is disposed behind the user, and manipulate the apparatus to massage a position on the back of the user. The extended structural support element (3) further comprises a planar body (13) having a planar back surface (15), which planar back surface (15) is configured to be braced against a flat surface such as a wall.

The invention has been described with reference to a preferred embodiment. However, it will be appreciated that variations and modifications can be effected by a person of ordinary skill in the art without departing from the scope of the invention.

Further aspects and/or embodiments of the invention are described in the following clauses:
Clause 1: An apparatus for use in massage, the apparatus comprising an extended structural support element and disposed at a first end portion of the structural support element at least one massage member and at a second end portion distal to the first end portion two gripping members, which two gripping members are laterally disposed on the structural support element relative to one another, the apparatus configured such that a user in a standing position with their arms at rest by their sides may grip the two gripping members, when the support structure is disposed behind the user, and manipulate the apparatus to massage a position on the back of the user.
Clause 2. An apparatus according to clause 1, wherein the structural support element is configured to be braced against a flat surface such as a wall.
Clause 3. An apparatus as defined in clause 1 or clause 2, wherein a position at which the at least one massage member is disposed on the structural support element and the positions at which the at least two gripping members are disposed on the structural support element together define a plane and wherein the massage member protrudes from, and the gripping members are configured to be gripped from, a front side of the plane.
Clause 4. An apparatus according to clause 3, wherein the extended structural support element comprises a planar body having a planar hack surface configured to abut a planar surface, such as a wall.
Clause 5. An apparatus as defined in clause 3 or clause 4, wherein a roller arrangement or low-friction material is disposed on the extended structural support about a back side of the plane or on a planar back surface.
Clause 6. An apparatus as defined in any one of the preceding clauses, wherein the massage member is medially disposed on the structural support element.
Clause 7. An apparatus as defined in any one of the preceding clauses, wherein the positions at which the two gripping members are disposed on the structural support element define a first axis, and wherein the at least one massage member is disposed on a second axis perpendicular to and medially intersecting the first axis.
Clause 8. An apparatus according to clause 7, wherein the distance between the at least one massage member and the first axis is adjustable.
Clause 9. An apparatus as defined in clause 7 or clause 8, wherein the distance between the at least one massage member and the first axis is at least 15 cm.
Clause 10. An apparatus as defined in any one of the preceding clauses, wherein the apparatus comprises a singular massage member, such that a user can selectively massage a discrete area of their back.
Clause 11. An apparatus as defined in any one of the preceding clauses, wherein the at least one massage member comprises a massage head, which massage head is interchangeable.
Clause 12. An apparatus as defined in any one of the preceding clauses, wherein the at least one massage member comprises a vibration, heat or mechanical massaging function.
Clause 13. An apparatus as defined in any one of the preceding clauses, wherein the distance between the two gripping members is adjustable.
Clause 14. An apparatus as defined in any one of the preceding clauses, wherein the distance between the two gripping members is at least 35 cm, preferably at least 40 cm, such as from 40 cm to 49 cm.
Clause 15. An apparatus as defined in any one of the preceding clauses, wherein the two gripping members comprise a cushioned gripping surface.
Clause 16. A method of massaging using the apparatus of any one of clauses 1 to 15, the method comprising:
   a user positioning the apparatus to their rear and gripping the two gripping members at their sides, such that their spine and arms are in a neutral position;
   the user leaning their middle to upper back against the massage member of the apparatus, which apparatus is braced against a wall;
   the user adjusting the pressure they impart on their back by leaning and/or adjusting the position of contact with the massage member for optimal massaging while maintaining a neutral spine position.

Each of the embodiments defined by the above clauses may be incorporated, where the context allows, into an apparatus for use in massage and/or a method of massaging using the apparatus thereof according to the aspects of the invention set out above.

1. An apparatus for use in massage, the apparatus comprising
an extended structural support element and disposed at a first end portion of the structural support element at least one massage member and at a second end portion distal to the first end portion two gripping members, which two gripping members are laterally disposed on the structural support element relative to one another,
the apparatus configured such that a user in a standing position with their arms at rest by their sides may grip the two gripping members, when the support structure is disposed behind the user, and manipulate the apparatus to massage a position on the back of the user, and
wherein the extended structural support element is configured to be braced against a flat surface.

2. The apparatus as claimed in claim 1, wherein a position at which the at least one massage member is disposed on the structural support element and the positions at which the at least two gripping members are disposed on the structural support element together define a plane and wherein the massage member protrudes from, and the gripping members are configured to be gripped from, a front side of the plane.

3. The apparatus as claimed in claim 2, wherein the extended structural support element comprises a planar body having a planar back surface configured to abut a planar surface.

4. The apparatus as claimed in claim 2, wherein a roller arrangement or low-friction material is disposed on the extended structural support about a back side of the plane or on a planar back surface.

5. The apparatus as claimed in claim 1, wherein the massage member is medially disposed on the structural support element.

6. The apparatus as claimed in claim 1, wherein the positions at which the two gripping members are disposed on the structural support element define a first axis, and wherein the at least one massage member is disposed on a second axis perpendicular to and medially intersecting the first axis.

7. The apparatus as claimed in claim 6, wherein the distance between the at least one massage member and the first axis is adjustable.

8. The apparatus as claimed in claim 6, wherein the distance between the at least one massage member and the first axis is at least 15 cm.

9. The apparatus as claimed in claim 1, wherein the apparatus comprises a singular massage member, such that a user can selectively massage a discrete area of their back.

10. The apparatus as claimed in claim 1, wherein the at least one massage member comprises a massage head, which massage head is interchangeable.

11. The apparatus as claimed in claim 1, wherein the at least one massage member comprises a vibration, heat or mechanical massaging function.

12. The apparatus as claimed in claim 1, wherein the distance between the two gripping members is adjustable.

13. The apparatus as claimed in claim 1, wherein the distance between the two gripping members is at least 35 cm, preferably at least 40 cm, such as from 40 cm to 49 cm.

14. The apparatus as claimed in claim 1, wherein the two gripping members comprise a cushioned gripping surface.

15. A method of massaging using the apparatus of any of claims 1 to 11 claim 1, the method comprising:
a user positioning the apparatus to their rear and gripping the two gripping members at their sides, such that their spine and arms are in a neutral position; the user leaning their middle to upper back against the massage member of the apparatus, which apparatus is braced against a wall;
the user adjusting the pressure they impart on their back by leaning and/or adjusting the position of contact with the massage member for optimal massaging while maintaining a neutral spine position.

16. The apparatus as claimed in claim 1, wherein the flat surface is a wall.

17. The apparatus as claimed in claim 2, wherein the planar surface is a wall.

18. The apparatus as claimed in claim 1, wherein the distance between the two gripping members is at least 40 cm.

19. The apparatus as claimed in claim 1, wherein the distance between the two gripping members is from 40 cm to 49 cm.
